(19) United States
(12) Patent Application Publication
(10) Pub. No.: US 2018/0257720 A1
(43) Pub. Date: Sep. 13, 2018

(54) VEHICLE CONTROL DEVICE AND METHOD USING GYROSCOPE

(71) Applicant: Daewoo KIM, Seoul (KR)

(72) Inventor: Daewoo KIM, Seoul (KR)

(21) Appl. No.: 15/760,324

(22) PCT Filed: Sep. 13, 2016
(86) PCT No.: PCT/KR2016/010357

§ 371 Date: Mar. 15, 2018

(30) Foreign Application Priority Data
Sep. 15, 2015 (KR) 10-2015-0130058
Apr. 11, 2016 (KR) 10-2016-0043968

(51) Int. Cl. B62D 37/06; B62D 61/02; B62J 17/08; F16F 15/315

(52) U.S. Cl. CPC B62D 37/06; B62D 61/02; G01C 19/32; F16F 15/315; B62J 17/08

(57) ABSTRACT

Provided is an apparatus for controlling a vehicle, including a vehicle body including a wheel, a gyro pack fixed to the vehicle body to be movable by a movement unit, a gyroscope installed in the gyro pack, and a flywheel installed in the gyroscope, rotated by a power unit, and tilted by a tilting unit. The wheel consists of a pair of left and right wheels in a direction perpendicular to a direction of progress of the vehicle body, and the wheels are driven by driving devices independently driven, and are provided with steering units independently controlling steering angles of the wheels. The gyro pack is moved relative to the vehicle body by at least one link arm connected to the gyro pack and the vehicle, body, and one gyroscope is provided with at least two flywheels, axes of rotation and rotation directions of which coincide with each other.

### CROSS-REFERENCE TO RELATED APPLICATION

This application is the National Stage of international Application No. PCT/KR2016/010357, filed on Sep. 13, 2016, which claims the benefit of and priority to Korean Patent Application No. 10-2015-0130058 filed on Sep. 15, 2015 and Korean Patent Application No. 10-2016-0043968 filed on Apr. 11 2016, which are herein incorporated by reference in its entirety.

### TECHNICAL FIELD

The present invention relates to a gyroscope, and more particularly to an apparatus and method for controlling the attitude of a vehicle using a gyroscope.

### BACKGROUND ART

In recent years, technologies for two-wheel drive vehicles that do not fall down have been actively developed. Since such a two-wheel drive vehicle cases two wheels, it is equipped with a variety of devices which measure the center of weight of the vehicle and keep the balance of the vehicle, based on them. For example, technologies that utilize gyroscopes for adjusting balance are applied to two-wheel drive vehicles developed by Segway, Inc. or Lit Motors, Corp. Segway, Inc. has developed a drive vehicle in which two wheels are arranged in parallel in the direction perpendicular to the direction of progress of the vehicle, and Lit Motors, Corp. has developed a drive vehicle in which two wheels are arranged series in the direction perpendicular to the direction of progress of the vehicle.

However, these technologies may not be applied to heavy vehicles, as they are, since they are focused on compact vehicles such as wheelchairs, scooters, or motorcycles. As the moment of inertial and the angular velocity of a rotating flywheel are increased, the force for adjusting the balance is increased. For this reason, when the moment of inertial of the flywheel, a gyroscope takes a lot of time to immediately control the variation in angular velocity, which may lead to the deterioration of immediate control of balance. Particularly when the gyroscope uses a motor having high rated power to control the angular velocity of the flywheel having large moment of inertial, a load may be significantly increased. In addition, since the gyroscope includes the barge motor installed in a gimbal together with the means for controlling the orientation of the flywheel, its size or weight may be significantly increased.

Moreover, since both of Segway, Inc. and Lit Motors, Corp. develop a two-wheel drive vehicle on the promise that a few persons as one or two get on the vehicle, its control and design are conducted on the promise that the center of weight of the vehicle is positioned on the line connecting two wheels and the center of weight does not move much even though the vehicle moves.

Accordingly the technologies that are developed by Segway, Inc., or Lit Motors, Corp. may not be applied, as they are, to a vehicle in which it is difficult to position the center of weight of the vehicle on the line connecting two wheels due to a large number of occupants, or to a vehicle in which a considerably large moment is caused to balance the center of weight.

### DISCLOSURE

### Technical Problem

The present invention has been made in view of the above-mentioned problems, and an object thereof is to provide an apparatus for controlling a vehicle, which is applicable to a vehicle that may not be autonomously balanced because of having two or less wheels coming into contact with the ground while it is very difficult to keep the balance of a vehicle body since the vehicle is heavy and the center of weight thereof is not positioned on the axis of the wheel(s).

Another object of the present invention is to provide a method of controlling a vehicle, which is capable of keeping the balance of a vehicle even though various external factors affect the balance of the vehicle while the vehicle travels.

### Technical Solution

In accordance with one aspect of the present invention, an apparatus for controlling a vehicle includes a vehicle body including at least one wheel, a gyro pack fixed to the vehicle body so as to be movable in at least one direction of forward and backward or left and right directions, a movement unit that moves the gyro pack, at least one gyroscope installed in the gyro pack, at least one flywheel installed in the gyroscope, a power unit that rotates the flywheel, a tilting unit that tilts the flywheel, a sensor for measuring at least one of states of the vehicle body, an environment around the vehicle body, and the gyro pack, and an ECU that controls at least one of the movement unit, the power unit, and the tilting unit, based on signals measured by the sensor.

The wheel may consist of a pair of left and right wheels in a direction perpendicular to a direction of progress of the vehicle body. Here, the gyro pack may be moved relative to the vehicle body along a rail installed at one of the gyro pack and the vehicle body and a rail guide installed at the other thereof.

The gyro pack may be moved relative to the vehicle body by at least one link arm connected to both of the gyro pack and the vehicle body. Here, the link arm may consist of three link arms, and one of both ends of the link arms may be connected a universal joint. The lengths of the link arms may be individually adjusted.

At least two gyroscopes may be installed in the gyro pack.

The gyroscopes may be disposed in parallel in left and right directions in the vehicle body.

The gyroscopes may rotate in opposite directions.

The gyroscope may be installed in the gyro pack through a gimbal, and the gyro pack may include a tilting unit for tilting the gimbal about an axis extending in the forward and backward directions of the vehicle.

One gyroscope may be provided with at least two flywheels, the axes of rotation of which coincide with each other. The flywheels may have different moments of inertia (I) relative to the axes of rotation of the flywheels. The flywheels, the axes of rotation of which coincide with each other. may be driven by power units that provide torques independently.

The apparatus may further include a gyro pack pitching unit that tilts the gyro pack about an axis perpendicular to an axis of rotation and a tilt axis of the flywheel. Here, the gyro pack pitching unit may allow the gyroscopes to pitch independently. Here, the gyro pack may pitch by adjusting the lengths of the link arms.

The apparatus may further include a gyro pack yawing unit that rotates the gyro pack about an axis parallel to an axis of rotation of the flywheel. Here, the gyro pack may yaw by turning the link arms in opposite directions.

The apparatus may further include a gyro pack elevating unit that moves the gyro pack in upward and downward directions. Here, the gyro pack may be moved up and down by adjusting the lengths of the link arms.

The pair of wheels may be driven by driving devices that are independently driven. Here, each of the driving devices year driving the wheels may be installed in the wheel to rotate the wheel.

The wheels may be provided with steering units that independently control steering angles of the wheels.

The apparatus may further include a support bar that supports the vehicle body while coming into contact with the ground such that the vehicle body is not tilted when the vehicle does not travel.

In accordance with another aspect of the present invention, a method of controlling a vehicle, in order to control a gyro pack fixed to a vehicle body including a pair of left and right wheels so as to be movable in a direction perpendicular to a direction of progress of the vehicle body, the gyro pack including at least one gyroscope including at least one flywheel, the method includes adjusting at least one of an orientation and a rotational speed of the flywheel provided in the gyro pack and a position of the gyro pack, based on at least one of states of the vehicle body, an environment around the vehicle body, and the gyro pack, which are measured by a sensor.

The method may include, when the vehicle is changed from a non-traveling state to a traveling state, a step of adjusting at least one of the orientation and rotational speed of the flywheel and the position of the gyro pack such that the vehicle is kept parallel to the ground in the state in which an occupant gets on the vehicle, and a step of checking the horizontal state of the vehicle by the sensor and then separating a support bar, which comes into contact with and supports the ground so as not to tilt the vehicle body, from the ground, so that the vehicle body is supported by only the wheel on the ground.

When the vehicle ascends a slope, the distance between the vehicle and the ground may be detected by the sensor and the gyro pack may be at least moved backward so that the vehicle body is parallel to the slope. When the vehicle descends the slope, the distance between the vehicle and the ground may be detected by the sensor and the gyro pack may be at least moved forward so that the vehicle body is parallel to the slope. At least one of the orientation and rotational speed of the flywheel may be further adjusted such that the vehicle body is parallel to the ground.

The vehicle may include a pair of left and right wheels in the direction perpendicular to the direction of progress thereof. When the sensor checks that the vehicle is predicted to roll or is in a rolling state, at least one of the orientation and rotational speed of the flywheel may be further adjusted such that a moment is generated in a direction opposite to the rolling of the vehicle.

When the sensor checks that the vehicle is predicted to pitch in a direction of progress thereof or is in a pitching state in a forward direction, the gyro pack may be at least moved in a direction opposite the direction of progress. In addition, at least one of the orientation and rotational speed of the flywheel may be further adjusted such that a moment is generated in a direction opposite to the pitching of the vehicle.

In this case, when the sensor detects that an object is close to the front of the vehicle or a bump is present on the road in front of the vehicle, the vehicle may be predicted to pitch in the direction of progress thereof.

When the vehicle rotates to the left or the right, the gyro pack may be moved toward a center of a radius of rotation. In addition, the method may perform control for lowering a height of the gyro pack.

In addition, when the vehicle is predicted to yaw in a direction of mismatching with a rotation direction thereof or is in a yawing state, at least one of the orientation and rotational speed of the flywheel may be farther adjusted such that a moment is generated in a direction opposite to the yawing of the vehicle.

In addition, when the vehicle is predicted to roll in a centrifugal direction or is in a rolling state, at least one of the orientation and rotational speed of the flywheel may be farther adjusted such that a moment is generated in a direction opposite to the rolling of the vehicle.

In addition, at least one the orientation and rotational speed of the flywheel may be further adjusted such that a moment is generated in a direction in which a center of weight of the vehicle body is lowered so that a heavier side of front and rear sides of the vehicle body on the basis of an axis of at least wheel is closer to the ground.

### Advantageous Effects

In accordance with the present invention, a gyroscopic principle can be applied to a vehicle body and the position of a gyro pack including a gyroscope can be changed in the vehicle body. Therefore, it is possible to rapidly control a vehicle, the center of weight of which is not positioned on the axis of a wheel, or a heavy vehicle, in order to adjust the balance thereof.

In addition, it is possible to have a fast response time even though a heavy flywheel is used to utilize the gyroscopic principle.

In addition, it is possible to continuously keep the balance of a heavy vehicle having two left and right wheels in parallel while the center of weight of the vehicle, is not positioned on the central axis between the wheels, even though various external factors affect the balance of the vehicle while the vehicle travels.

Additional advantages, objects, and features of the invention will be set forth in part in the description which follows and in part will become apparent to those having ordinary skill in the art upon examination of the following or may be learned from practice of the invention.

### DESCRIPTION OF DRAWINGS

FIG. 1 is a control flowchart of an apparatus for controlling a vehicle according to an embodiment of the present invention.

FIG. 2 is a side view schematically illustrating a vehicle according to the embodiment of the present invention.

FIG. 3 is a top view schematically illustrating the vehicle according to the embodiment of the present invention.

FIG. 4 is a perspective schematically illustrating a gyro pack according to the embodiment of the present invention.

FIG. 5 is a cross-sectional view taken along line “A-A” of FIG. 4.

FIG. 6 is a perspective view illustrating an example of a movement unit of the gyro pack according to the embodiment of the present invention.

FIGS. 7(a)-7(e) are perspective views illustrating another example of a movement unit of the gyro pack according to the embodiment of the present invention.

FIGS. 8(a)-8(b) are views illustrating a case where a moment is generated by the gyro pack.

FIG. 9 is a control flowchart performed when the vehicle, which is equipped with the apparatus for controlling a vehicle, starts and stops operation according to the embodiment of the present invention.

FIGS. 10(a)-10(b) show a side view illustrating the attitude of the vehicle according to the embodiment or the present invention when the vehicle stops operation and travels.

FIGS. 11(a)-11(b) are views illustrating a vehicle body while the vehicle ascends the slope.

FIGS. 12(a)-12(b) are views illustrating a vehicle body while the vehicle descends the

FIG. 13 is a view illustrating a case where a bump is present in from of the vehicle body.

FIG. 14 is a view illustrating a case where braking must be perform since obstacles are present in front of the vehicle body.

FIG. 15 is a view illustrating a state in which the vehicle rolls to the left due to only a right hump on the ground.

FIG. 16 is a view illustrating a state in which the vehicle rolls to the right due to only a right recessed portion on the ground.

FIGS. 17(a)-17(e) are views illustrating a state in which the vehicle rotates to the left when viewed from the top.

### BEST MODEL

Hereinafter, exemplary embodiments of the present invention will be described in detail with reference to the accompanying drawings.

The present invention may, however, be embodied in different forms and should not be construed as limited to the embodiments set forth herein. Rather, these embodiments are provided so that this disclosure will be thorough and complete, and will fully convey the scope of the present invention to those skilled in the art.

[Vehicle Control System]

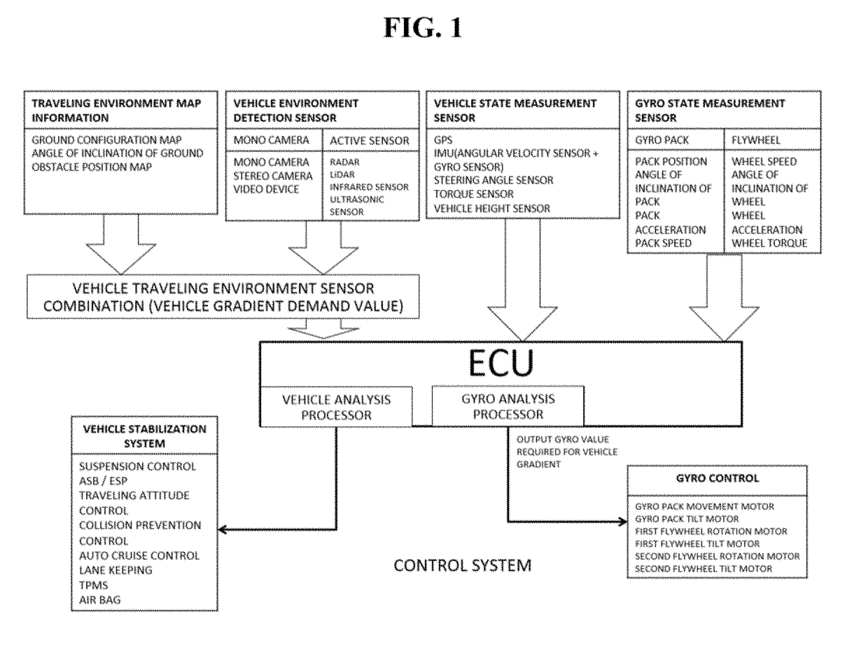

FIG. 1 is a control flowchart of an apparatus for controlling a vehicle according embodiment of the present invention.

The apparatus for controlling a vehicle according to the embodiment of the present invention will be described with reference to a vehicle, the attitude of which is unstable due to having two or less wheels, However, the apparatus for controlling a vehicle according to the embodiment the present invention may also he applied to a vehicle, the attitude of which is relatively stable owing to having three or more wheels.

The vehicle requires a variety of data about a vehicle body in order to stably control the attitude of the vehicle body. To this end, the current speed of the vehicle, the direction of progress of the vehicle, the acceleration and deceleration information of the vehicle, and the distance between the multiple positions of the vehicle body and the ground are detected and measure by various sensors, such as a global positioning system (GPS), a speed sensor, an acceleration sensor, a gyro sensor, a sensor for measuring the distance between the ground and the vehicle body, etc., provided in the vehicle, and are transmitted to an ECU.

In addition, one object of the present invention is to stably keep the attitude of the vehicle using a gyroscope. To this end, it is necessary to continuously update the current state of the gyroscope. Accordingly, the present invention continuously detects and updates information about the position of a gyro pack, which includes the gyroscope and will be described later, the angle of inclination of the gyro pack, the speed of the gyro pack, the acceleration of the gyro pack, the speed of the flywheel of the gyroscope, the acceleration of the flywheel, the direction of the axis of rotation of the flywheel, etc.

In addition, the present invention checks map information on traveling environment around the vehicle, a database being already established in the map information. That is, the surrounding environment information corresponding to the current position of the vehicle is extracted using the GPS which is a portion of the sensors for measuring the state of the vehicle, and is provided to the ECU. For example, it is possible to calculate the angle of inclination of the ground on which the vehicle is currently located by comparing the direction of progress of the vehicle with the topographic map in the database, to extract information about the properties of the ground, e.g. about whether the road is an asphalt road or an unpaved road, and to extract whether or not an obstacle is present on the road in the current direction of progress of the vehicle and position information on the obstacle. It is possible to access the database by connecting to internet network in real time through short-range wireless communication such as Wi-Fi or long-range wireless communication such as 3G or LTE, or the database may be continuously updated in the memory of the vehicle.

In addition, the present invention actually detects the current state of the ground or surrounding geographic feature and the surrounding environment of the road on which the vehicle travels, using a mono or stereo camera or video device, an infrared or ultrasonic sensor, a radar, an LIDAR, or the like, and provides them to the ECU.

In this case, the information obtained by extracting the traveling environment of the vehicle from the map is combined with the information which is directly detected by the sensors installed in the vehicle. In addition, the ECU determines how to control the current vehicle, based on the combined traveling environment of the vehicle. For example, it is possible to derive an ideal attitude for stably driving the vehicle, based on the current measured information.

The method of controlling the vehicle based on the current measured environment around the vehicle and the current attitude or state of the vehicle includes control of various functions, such as vehicle suspension control, vehicle body attitude active control, collision prevention control, auto cruise control, and airbag development.

In addition, in order to stably maintain the vehicle which may be often in an unstable state, the present invention moves the gyro pack, tilts the gyro pack, regulates the rotational speed of the flywheel of the gyroscope included in the gyro pack, or adjusts the direction of the axis of rotation of the flywheel so as to control them. Thereby, the overall center of weight of the vehicle may move in a more stable direction by moving the center of weight of the gyro pack, and the gyroscope may generate a moment for stably supporting the vehicle body so as to stably keep the attitude of the vehicle body.

[Overall Structure of Vehicle According to the Present Invention]

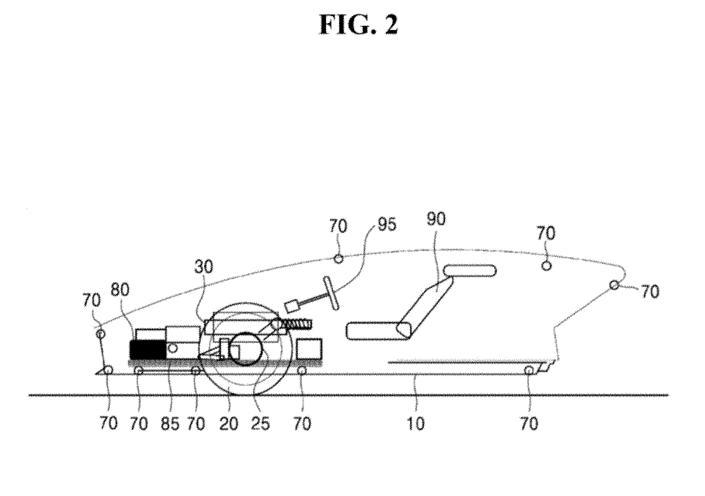

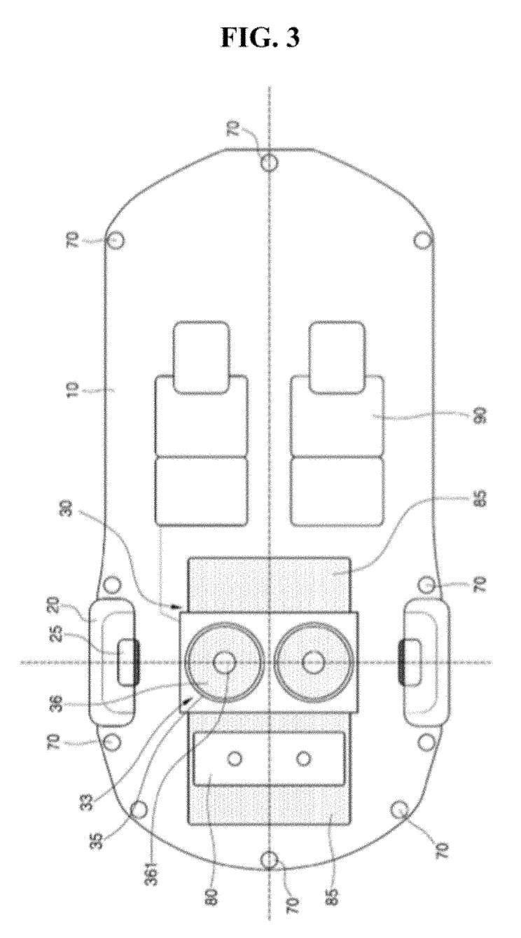

FIG. 2 is a side view schematically illustrating the vehicle, according to the embodiment of the present invention. FIG. 3 is a top view schematically illustrating the vehicle according to the embodiment of the present invention.

In the embodiment of the present invention, wheels 20 are installed to the front left and right sides of a vehicle body 10, respectively. The wheels 20 are preferably connected to the vehicle body 10 by a suspension so as not to directly transfer impact to the vehicle body 10 from the ground. The wheels 20 are driven by in-wheel motors which are separate drive units 25, respectively. The drive units of the wheels are independently driven and controlled. That is, the rotational driving speeds of the wheels 20 installed to the front left and right sides of the vehicle body 10 may be controlled independently in the present invention.

In addition, each of the wheels may be steered in left and right directions in the present invention. The steering angle of each of the wheels may be individually and independently controlled. For example, the left wheel may be rotated to the right relative to the front at a steering angle of 20°, and the right wheel may be rotated to the right relative to the front at a steering angle of 15°.

This structure differs from that of a typical four-wheel vehicle. That is, when the typical four-wheel vehicle travels on the curved road, the facing direction of the vehicle traveling on the curved road is determined by rear wheels. Since two front wheels which are steered have different centers of turning and radii, the steering angles and rotational speeds of the front wheels are determined according to the different centers of turning and radii in order to prevent the abrasion of tires.

In addition, the method of determining the facing direction of the vehicle traveling on the curved road by the rear wheels is performed similar to a two-wheel vehicle having one wheel at each of the front and rear thereof; namely a so-called motorcycle. That is, in a vehicle including two wheels having central axes of rotation at different positions on the basis of the direction of progress of the vehicle, the facing direction of the vehicle traveling on the curved road is determined by a difference between the steering directions of the rear and front wheels.

In addition, when an existing motor vehicle by Segway, Inc. travels at different rotational speeds of two wheels on the curved road in the state in which the left and right wheels are not steered, the radius of rotation of the motor vehicle traveling on the curved road is also determined by a difference between the rotational speeds of the wheels, and the forward facing direction of the motor vehicle on the curved road coincides with the tangent of the curved road. That is, the forward facing directions of the above-mentioned four-wheel two-wheel vehicle, and the motor vehicle by Segway, Inc. on the curved road are previously determined.

However, the vehicle according to the present invention has only two front wheels without rear wheels, as illustrated in the drawings. That is, the vehicle according to the present invention is a vehicle having only two front wheels having one central axis of rotation on the basis of the direction of progress of the vehicle. In the vehicle according to the present invention, the rotational speeds and steering angles two wheels may be independently controlled, unlike the motor vehicle by Segway, Inc.

In this case, the above-mentioned vehicle differs from the vehicle of the present invention in terms of drive mechanism. That is, in the vehicle of the present invent having only two front wheels while the rotational speeds and steering angles of the wheels may be independently controlled, the facing direction of the vehicle traveling on the curved road may be freely controlled relative to the trajectory of the curved road.

In more detail, first, an existing four-wheel vehicle, which steers front wheels, travels on the curved road while it is directed further outward than the tangent of the trajectory of the curved road. A conventional two-wheel vehicle (a motorcycle having front and rear wheels), which steers the from wheel, travels the same manner.

Secondly, on the other hand, an existing four-wheel heavy vehicle, which steers rear wheels, such as a fork lift, travels on the curved road while it is directed further inward than the tangent of the trajectory of the curved road.

Thirdly, in the above-mentioned motor vehicle by Segway, Inc. traveling on the curved road only by the difference between the rotation speeds of the two wheels without the steering of the wheels, the tangent a the trajectory of the curved road coincides with the facing direction of the vehicle.

In the above three cases, the facing direction of the vehicle is determined in advance relative to the trajectory of the curved road.

However, in the vehicle of the present invention having only two front wheels while the rotational speeds and steering angles of the wheels may be independently controlled, the facing angle of the vehicle to the tangent of the curved road may be arbitrarily adjusted. That is, even when the vehicle travels on the curved road only by the difference between the rotation speeds of front left and right wheels without the steering of the wheels, the facing direction of the vehicle may coincide with the tangential direction of the curved road. In addition, when the steering and driving speeds of the front wheels are independently controlled in the vehicle of the present invention without having rear wheels, the vehicle may travels by various trajectories and attitudes. For example, when the driving speeds of the front left and right wheels coincide with each other in the state in which the wheels are steered at the same angle, the vehicle may change lanes in the state in which the vehicle is accurately directed forward. In addition, according to the present invention, when the vehicle turns on the curved road, it is possible to freely select and control the facing directions of the vehicle relative to the tangents of the trajectories of the curved road in the initial, middle, and end portions of the curved road. These methods may be utilized to secure driver's pleasant driving, viewing on the curved road, the comfort of the driver seated in the vehicle corresponding to the centrifugal force on the curved road, and the stability of the attitude of the vehicle on the curved road. In addition, this enables the driver to control and experience new driving other than existing driving.

In addition, a flat battery 85 is installed on the vehicle body so as to traverse the central axis connecting the centers of rotation of the two wheels. The battery 85 is a heavy part, and a large portion of the battery is disposed in front of the vehicle from the central axis connecting the centers of rotation of the wheels. That is, the center of weight of the battery is positioned slightly forward from the central axis between the wheels. This causes the center of weight of the vehicle to be positioned as close as possible to the central axis between the wheels when a person gets on the vehicle, considering that seats 90 on which persons are seated are located behind the central axis between the wheels. The battery is a secondary battery, and may be charged in a wired or wireless manner.

A gyro pack 30 is installed above the battery, and is located on the central axis between the wheels. Two gyroscopes 33 are arranged parallel along the central axis between the wheels in the gyro pack. Each of the gyroscopes has a flywheel 36, and the flywheel is rotated by a power unit 361 such as a rotary motor.

An ECU 80 is installed in front of the gyro pack 30. In addition, a variety of vehicle components, such as an inverter and a converter, are installed in the vicinity of the ECU and in front of the central axis between the two wheels 20 in order to convert the electric power of the battery into electric power required by a power requirement unit.

A steering wheel 95 is an electronic steering device, and has a sensor for measuring the angular displacement of the steering wheel. The vehicle is steered by a difference between the driving speeds of the two wheels 20 occurring according to the angular displacement of the steering wheel measured by the sensor.

The seats 90, on which persons are seated, are provided behind the steering wheel. The vehicle body of the present invention has a width similar to that of a typical vehicle, and is thus provided with a pair of left and right seats.

A variety of sensors 70 are installed in the vehicle, and measure various types of vehicle environment information, vehicle state information, gyro state information, etc., which are described with reference to FIG. 1, to provide them to the ECU 80.

[Structure of Gyro Pack and Movement Structure of Gyro Pack]

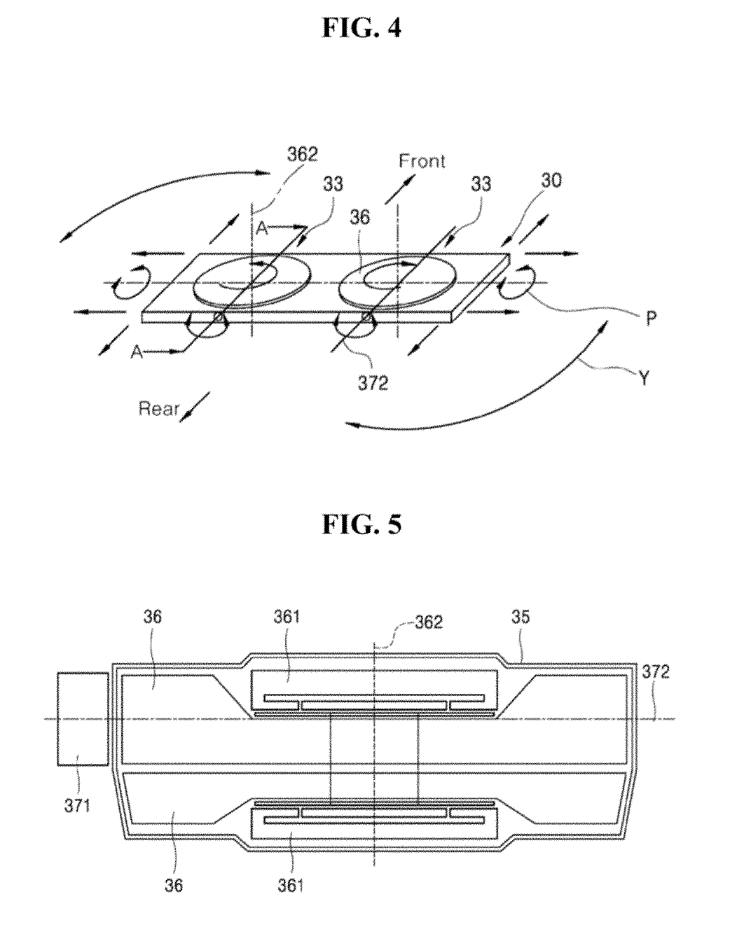

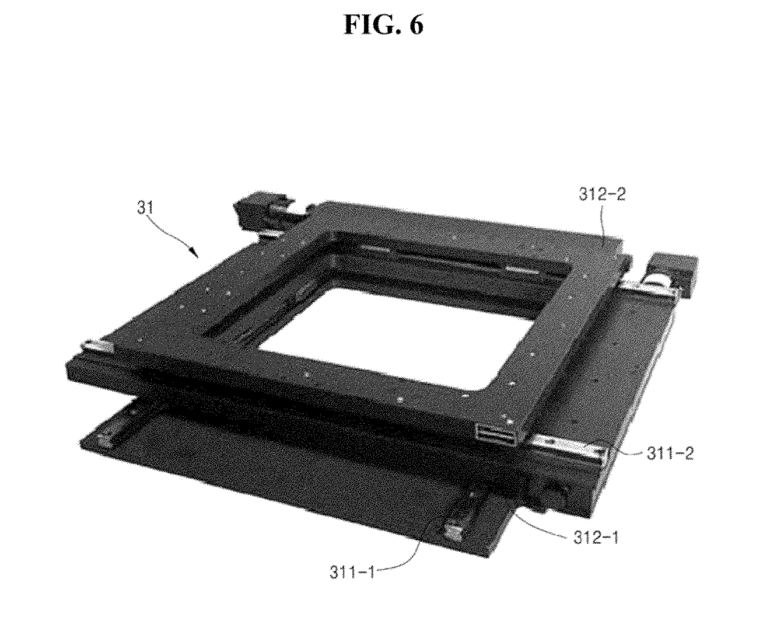

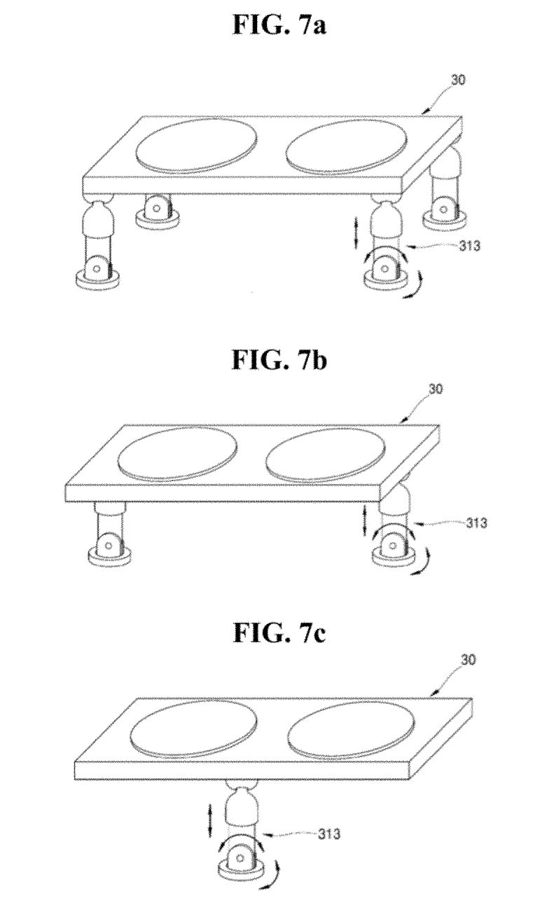

FIG. 4 is a perspective schematically illustrating the gyro pack according to the embodiment of the present invention. FIG. 5 is a cross-sectional view token along line “A-A” of FIG. 4. FIG. 6 is a perspective view illustrating an example of a movement unit of the gyro pack according to the embodiment of the present in FIGS. 7(a)-7(c) are perspective views illustrating another example of a movement unit of the gyro pack according to the embodiment of the present invention.

The gyro pack 30 of the present invention, which is laterally installed in the vehicle body, includes the two gyroscopes 33 which are disposed parallel in the left and right directions of the vehicle body, as illustrated in FIG. 4. The respective gyroscopes include flywheels 36 having different moments of inertial and the rotary motors 361 which respectively drive the flywheels.

The axes of rotation of the flywheels illustrated in FIG. 5 coincide with each other. The upper flywheel is rotated by the torque transferred from the upper motor 361, and the lower flywheel is rotated by the torque transferred from the lower motor. The directions of rotation of the upper and lower flywheels coincide with each other. Each of the flywheels is accommodated in a gimbal 35, which also serves as a housing, and rotates in the gimbal. The gimbal is rotated at a required angle about a tilt axis 372 by a tilt motor 371 as a tilting unit. The tilt unit may rotate the flywheel about the tilt axis 372 so as to adjust the orientation of the axis of rotation of the flywheel. When one gyroscope includes the two flywheels having different moments of inertia, the flywheel having a relatively small moment of inertia may be rapidly accelerated or decelerated so as to increase or decrease the rotational speed of the flywheel. Therefore, it is possible to have a fast response time when the moment is controlled by the gyroscope. The rotary motor, driving the flywheel, functions as a generator when the speed of the flywheel is reduced, and thus it is possible to convert the rotary kinetic energy of the flywheel into electric energy.

As illustrated in FIG. 4, the flywheels installed in the respective gyroscopes 33 rotate in opposite directions. Thus, among the moments generated by the two gyroscopes, a desired moment is not cancelled, and an undesired moment is canceled. In addition, the tilting angle of each of the gyroscopes 33 may be controlled by the tilting unit such that the gyroscope is tilted by an amount required for control about the tilt axis extending in the forward and backward directions.

Referring to FIG. 4, the gyro pack 30 of the present invention may translate in the forward and backward directions and/or in the left and right directions, as illustrated in the drawing, and may realize pitching (P) and yawing (Y).

As illustrated in FIG. 6, in order to translate the gyro pack 30, a rail guide 312-1 is installed on a rail 311-1 extending in the forward and backward directions, and the rail guide 312-1 may move in the forward and backward directions. In addition, a rail 311-2 extending in the left and right directions is installed on the rail guide 312-1 moving in the forward and backward directions, and a rail guide 312-2 engages with the rail 311-2, thereby enabling the rail guide 312-2 to move along the rail 311-2 in the left and right directions. The gyro pack 30 is installed on the rail 312-2. Accordingly, the forward and backward movement and/or left and right movement of the gyro pack 30 may be controlled by controlling the positions of the two rail guides relative to the two rails using a linear motor or the like. Here, the gyro pack 30 may be installed so as to realize pitching (P) relative to the rail guide 312-2. A motor may be used as the pitching unit of the gyro pack.

FIGS. 7(a)-7(c) illustrate that the gyro pack is moved in a different manner from that illustrated in FIG. 6, rotates in a pitching or yawing direction, and moves up and down. Referring to FIG. 7(a), the gyro pack 30 is installed so as to be supported by four link arms 313 on the installation surface of the vehicle body. Each of the link arms 313 has a unit formed at the lower end thereof in order to rotate the link arm about a vertical axis, and has a unit formed at the upper portion of the unit in order to rotate the link arm about a horizontal axis. The link arm is longitudinally expanded and contracted in a hydraulic manner by a ram or the like. The lengths of the link arms may be independently adjusted. The upper ends of the link arms are connected to the gyro pack 30 by a universal joint.

Accordingly, when the four link arms are rotated forward in parallel, the gyro pack is moved forward. When the link arms are rotated to the right in parallel, the gyro pack is moved to the right. When all of link arms are moved in the same direction, the gyro pack is movable.

Next, among the four link arms, when two rear link arms are expanded and two front link arms are contracted, the gyro pack rotates in the pitching direction, and vice versa.

Next, among the four link arms, when two right link arms are rotated forward and two left link arms are rotated backward, the gyro pack rotates in the yawing direction, and vice versa. Moreover, among the four link arms, when two rear link arms are rotated to the right and two front link arms are rotated to the left, the gyro pack rotates in the yawing direction.

In addition, when all of four link arms are expanded or contracted, the gyro pack moves up or down.

As described above, the movement, pitching and yawing of the gyro pack may be realized by the four link arms having the above-mentioned configuration. Although not described above, the gyro pack may rotate in a rolling direction. That is, the four link arms serve as a unit for moving the gyro pack, and simultaneously serve as a pitching unit, a yawing unit, a rolling unit, and an elevating unit.

The number or degrees of freedom of link arms may be properly selected according to the movement or rotation of the gyro pack. For example, when there are three link arms, only two among them may have an expansion/contraction structure, and various modifications may be made. FIG. 7(b) illustrates an example installation of two link arms. As illustrated in FIG. 7(b), when the link arms are installed at the central portions of both ends of the gyro pack in the longitudinal direction thereof, the load or moment generated by the gyroscope may be minimized by only the two link arms so that the position attitude of the gyro pack may be controlled. As illustrated in FIG. 7(c), both movement and rotation of the gyro pack may be realized in all directions by only one link arm. When the link arm supports the load and moment applied thereto, the movement and rotation of the gyro pack may be realized by only one link arm.

Meanwhile although the present invention illustrates the structure in which the gyro pack provided with the two gyroscopes generally pitches, the present invention may be applied to a structure in which the two gyroscopes installed in the gyro pack pitch respectively. In addition, the present invention is not limited to two gyroscopes, and the present invention is not limited to two flywheels provided in one gyroscope.

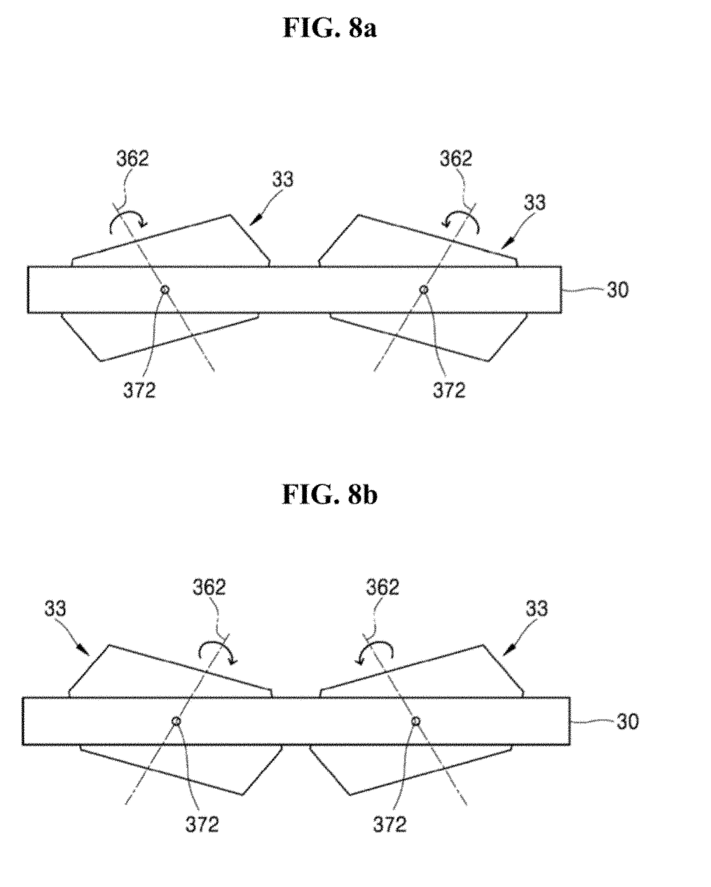

Referring to FIGS. 8(a)-8(b) illustrating a case where a moment is generated by the gyro pack, the flywheels of the two gyroscopes 33 rotate in opposite directions. The direction of the moment generated when the gyroscopes are arranged as illustrated in FIG. 8(a) is opposite to the direction of the moment generated when the gyroscopes are arranged as illustrated in FIG. 8(b). In order to accurately control the direction and site of the moment intended for generation, the rotational speeds and directions of the axes of rotation of the flywheels of the two gyroscopes may be individually controlled. That is, all of the moment in the pitching direction, the moment in the rolling direction, and the moment in the yawing direction, which are applied to the vehicle body by the gyroscopes, may be controlled by adjusting the rotational speeds and directions of the axes of rotation of the flywheels of the gyroscopes. The direction of the moment applied to the vehicle body may be further controlled by the pitching (P) and yawing (Y) of the vehicle body.

[Orientation of Gyroscope and Vehicle Body Attitude Control by Movement and Rotation of Gyro Pack]

Hereinafter, the method of controlling the vehicle body of the vehicle equipped with the gyro pack and the movement unit thereof according to the present invention will be described in detail.

The two-wheel drive vehicle by Segway, Inc. has been developed on the promise that it has two leaf and right wheels and the center of weight of the vehicle is positioned on the fine connecting the wheels. Thus, the attitude control of the vehicle is performed by controlling the size and direction of the acceleration of a vehicle body such that the acceleration obtained by the sum of the acceleration of gravity corresponding to the center of weight and the acceleration of the vehicle body is directed to the center between the wheels.

In addition, the two wheel drive vehicle by Lit Motors, Corp. has been developed on the promise that it has front and rear wheels and the center of weight of the vehicle positioned on the line connecting the wheels. Thus, the attitude control of the vehicle is performed by generating a complementary moment using, a gyroscope when a vehicle body having the front and rear wheels is in an unstable state in which the vehicle stops or travels at a low speed, and when a moment is applied in the direction in which the vehicle body falls down due to external force caused when impact is applied to the vehicle, body due to external factors.

However, the present invention is developed on the promise that the center of weight of the vehicle is not positioned on the line connecting the two wheels. As a result, the attitude control of the vehicle is performed by continuously controlling load movement and generation of the moment of the gyroscope according to the position and/or rotation of the gyro pact, based on various types of information inside/outside the vehicle while the vehicle travels.

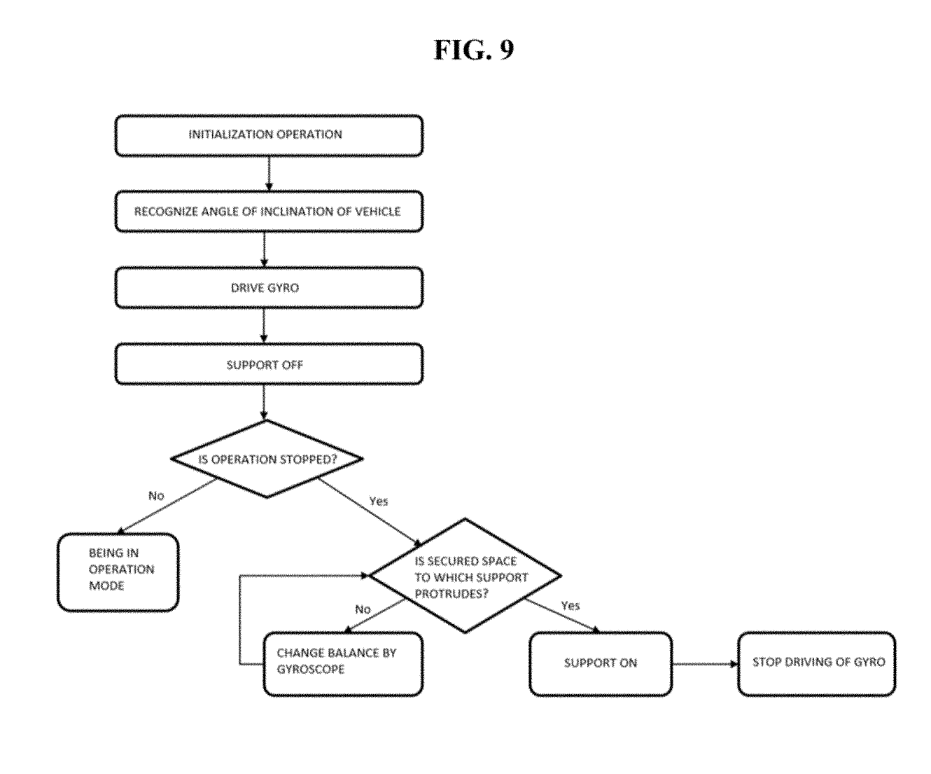

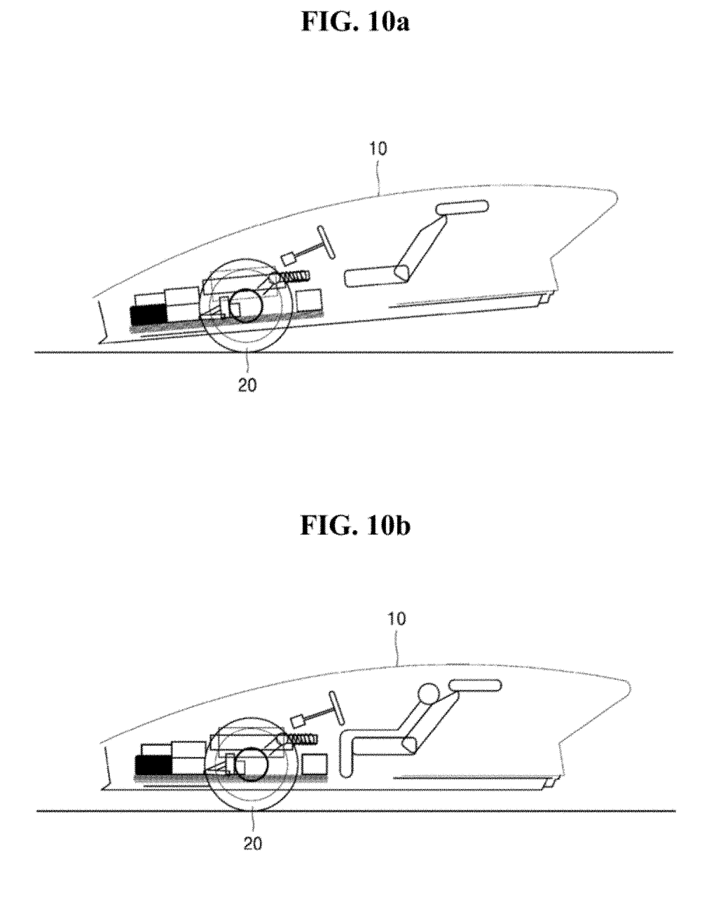

FIG. 9 is control flowchart performed when the vehicle, which is equipped with the apparatus for controlling a vehicle, starts and stops operation according to the embodiment of the present invention. FIGS. 10(a)-10(b) show a side view illustrating the attitude of the vehicle according to the embodiment of the present invention when the vehicle stops operation and travels.

Referring to FIG. 10(a), large load is distributed to the wheel 20 in front of the vehicle body 10 in the state in which no person gets on the vehicle and the vehicle is stopped, and thus the vehicle is tilted forward. Since the gyroscope is stopped when the vehicle does not travel, supports (not shown) for supporting the vehicle protrude downward from the front and rear of the vehicle body, and supports the vehicle body on the ground.

When a person gets on the vehicle and the vehicle is started for operation, the sensor checks a support to which a larger load is applied among the front and rear supports, and the associated support is then inserted into the vehicle. Again, the angle of inclination of the vehicle and/or the distance between the lower surface of the vehicle and the ground in each of the front and rear of the vehicle are measured by the sensor.

In order for the vehicle to have a flat attitude relative to the ground, the gyro pack is moved in a required direction from among forward and backward directions and the gyroscope is simultaneously operated. For example, when the front of the vehicle body is lifted and the rear thereof is lowered, the gyro pack is moved forward and the gyroscope generates a moment that lifts the rear of the vehicle body. After the vehicle body is stably controlled so as to be located parallel to the ground, both supports are inserted into the vehicle body. Then, the vehicle is kept in the state illustrated in FIG. 10(b).

According to the embodiment of the present invention, the seat 90 on which a person is seated is located behind the central axis between the two wheels, and the position of the center of weight may vary according to various variables, such as the weight of an occupant, the number of occupants, the posture of an occupant, and the position adjustment of the seat on which a person is seated. Therefore, as described above, the vehicle travels in a default state in which the center of weight of the vehicle is not positioned on the line connecting the wheels. Accordingly, in order maintain the default state illustrated in FIG. 10(b), the state, in which the gyro pack is moved forward and the gyroscope generates moment that lifts the rear vehicle body for controlling the tilt angle and rotational speed thereof, is in a default control state.

Meanwhile, after the traveling of the vehicle is completed, the sensor checks whether a space to which supports protrude is present on the ground, and the supports protrude. In this case, when there is no space to which the supports protrude, the sensor checks whether as space to which the supports protrude is secured by adjusting the balance of the vehicle body through the position of the gyro pack and the control of the gyroscope, and then the supports protrude.

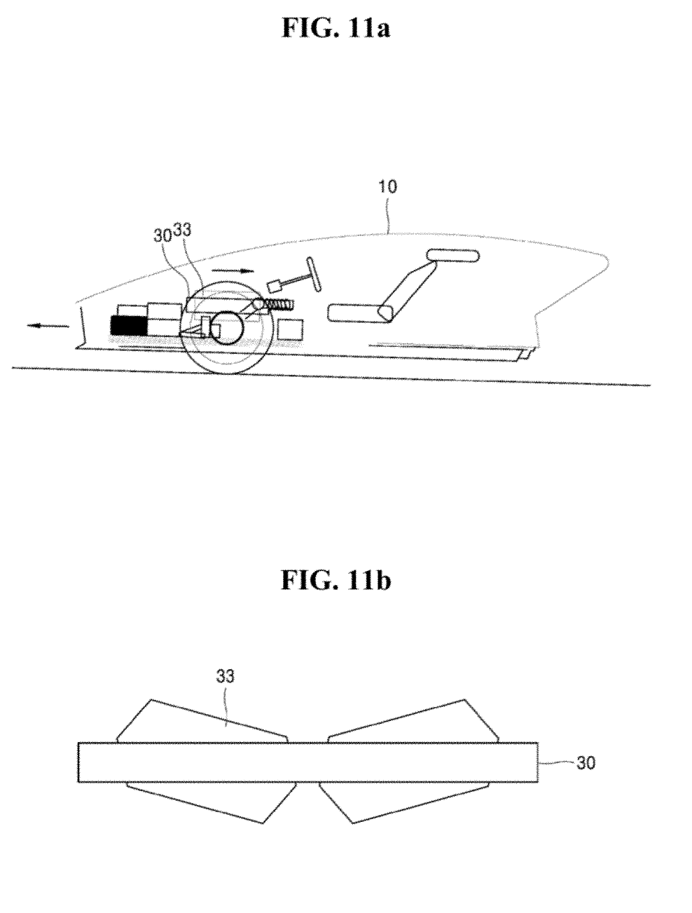

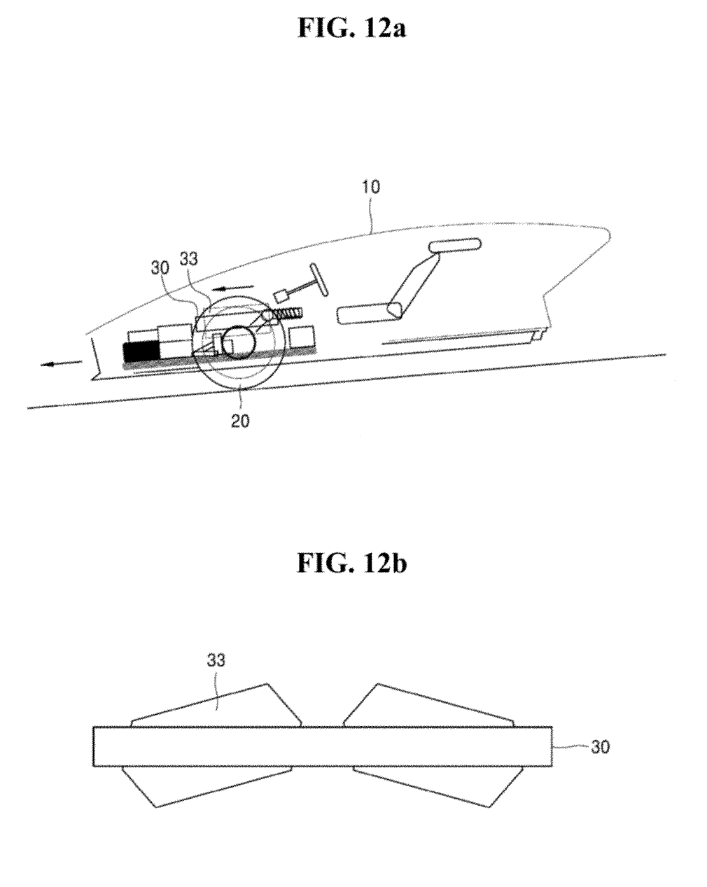

FIGS. 11(a)-11(b) are views illustrating the vehicle body while the vehicle ascends the slope. FIGS. 12(a)-12(b) are views illustrating the vehicle body while the vehicle descends the slope.

When the vehicle traveling on the flat road and enters the slope, the vehicle ascends the slope in the state in which the vehicle body is perpendicular to the direction of gravity by the action of the gyroscope. In this case, the front of the vehicle body may come into contact with the ground. Accordingly, in order for the vehicle body to be parallel to the ground when the vehicle ascends the slope, the vehicle body must be controlled such that the rear of the vehicle is further lowered relative to the direction of gravity.

To this end, when the gyro pack 30 is slightly moved backward as illustrated in FIG. 11(a) and the speed of the flywheel is properly regulated while the gyroscope is oriented as illustrated in FIG. 11(b), the attitude of the vehicle body may be controlled as illustrated in FIG. 11(a). The movement of the gyro pack and the orientation and rotational speed of the gyroscope may he simultaneously or selectively adjusted. In this case, the distance between the ground and each of the front and rear bottoms of the vehicle body is continuously monitored by the sensor.

On the other hand, when the vehicle traveling on the flat road and descends the slope, the rear of the vehicle body may come into contact with the ground. Accordingly, in order for the vehicle body to be parallel to the ground when the vehicle descends the slope, the vehicle body must be controlled such that the rear of the vehicle is further lifted relative to the direction of gravity.

To this end, when the gyro pack 30 is slightly moved for yard as illustrated in FIG. 12(a), and the speed of the flywheel is properly regulated while the gyroscope is oriented as illustrated in FIG. 12(b), the attitude of the vehicle body may be controlled as illustrated in FIG. 12(a). The movement of the gyro pack and the orientation and rotational speed of the gyroscope may he simultaneously or selectively adjusted. In this case, the distance between the ground and each of the front and rear bottoms of the vehicle body is continuously monitored by the sensor.

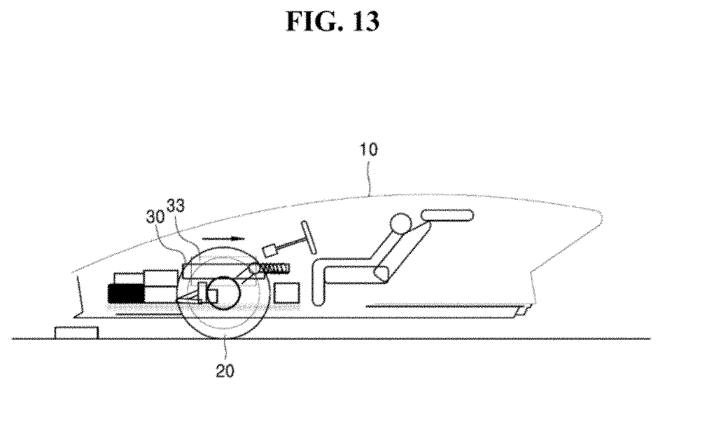

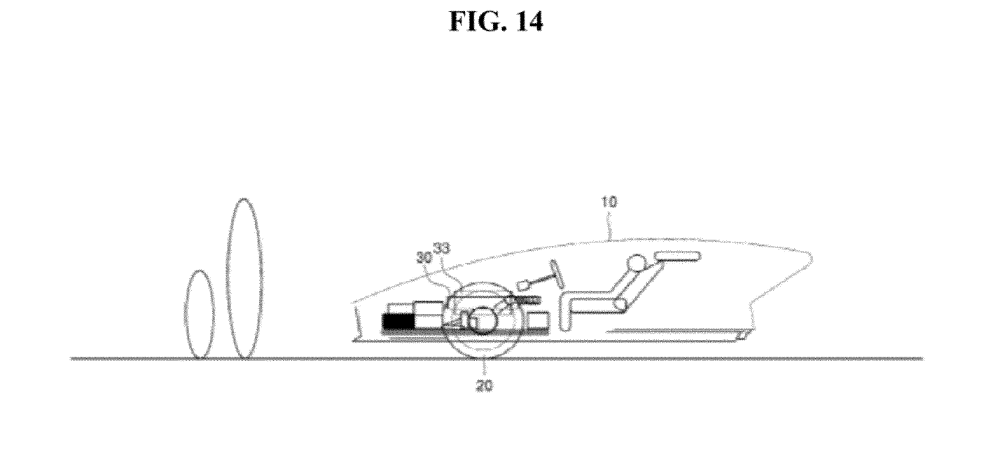

FIG. 13 is a view illustrating a case where a bump is present in front of the vehicle body. FIG. 14 is a view illustrating a case where braking must be performed since obstacles are present in front of the vehicle body.

In FIG. 13, the sensor installed in the lower portion of the vehicle body detects the hump on the ground. The ECU may estimate a time when impact occurs due to collision between the vehicle and the bump, based on the position of the bump and the speed of the vehicle, and thus the attitude control of the vehicle may be prepared in advance. For example, when the vehicle collides with the bump, the vehicle may lean forward. In order to prepare for this situation, the gyro pack 30 is moved backward, and the tilt angle of the gyroscope and the rotational speed of the flywheel are controlled. The movement of the gyro pack and the orientation and rotational speed of the gyroscope may be simultaneously or selectively adjusted. In FIG. 14, the above method is similarly performed. That is when an obstacle is in front of the vehicle, the ECU may predict the intensity and time of braking of the vehicle, based on the position of the obstacle and the speed of the vehicle, and thus the attitude control of the vehicle may be prepared in advance. In order to prepare for this situation, the gyro pack 30 is moved backward, and the tilt angle of the gyroscope and the rotational speed of the flywheel are controlled. The movement of the gyro pack and the orientation and rotational speed of the gyroscope may be simultaneously or selectively adjusted.

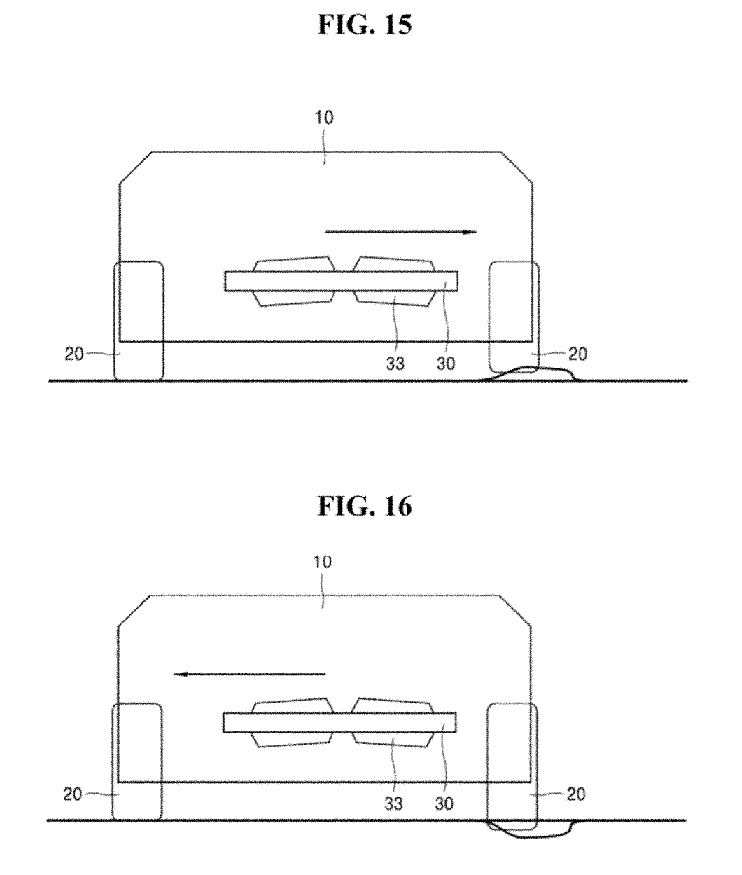

FIG. 15 is a view illustrating a state in which the vehicle rolls to the left due to only a right bump on the ground. FIG. 16 is a view illustrating a state in which the vehicle rolls to the right due to only a right recessed portion on the ground.

As illustrated in FIG. 15, when the vehicle rolls to the left, the load of the vehicle leans to the left. In this case, slip may occur between the right wheel 20 and the ground. Accordingly, in order to prevent the vehicle, from turning over or sliding, the gyro pack 30 is moved to the right. According to the position control of the gyro pack, the center of weight of the vehicle body is moved to the right so that a large load is applied to the right wheel 20, thereby preventing the overturn of the vehicle and further securing traction between the right wheel and the ground.

In addition, the gyro pack and the gyroscope may be controlled such that a moment is generated in the direction against the rolling of the vehicle body to the left. For example, a moment may be generated in the direction against the rolling of the vehicle body by pitching the two gyroscopes in opposite directions. The movement of the gyro pack and the orientation and rotational speed of the gyroscope may be simultaneously or selectively adjusted.

Since this method may be similarly applied to the case of FIG. 16, a detailed description thereof will be omitted.

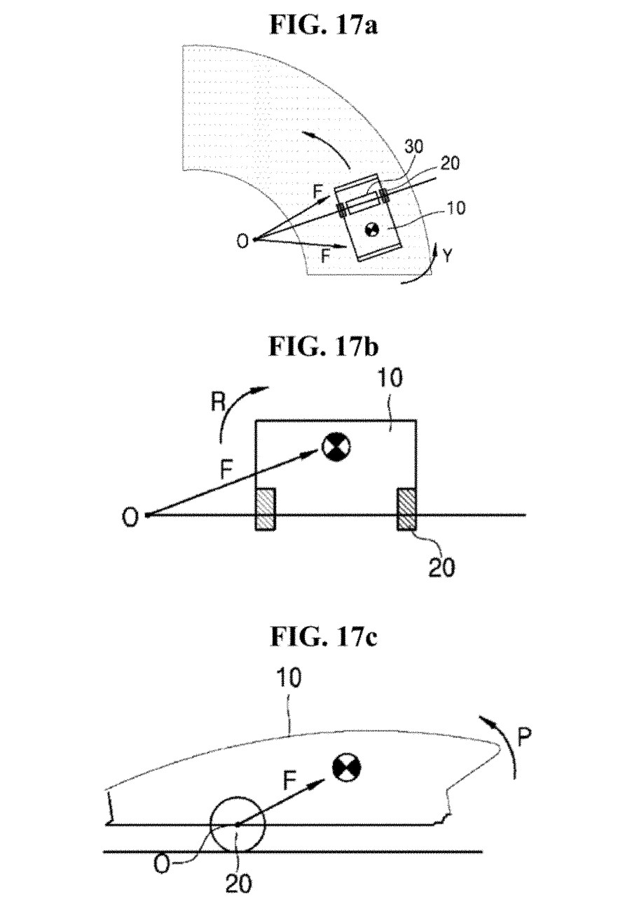

FIGS. 17(a)-17(c) are illustrating a state which the vehicle rotates to the left when viewed from the top.

When the vehicle rotates as illustrated in the drawing, the acceleration of gravity and the acceleration in the direction of moving away from the center of the radius of rotation (O) are applied to the vehicle. However, since the vehicle according to the present invention includes only two left and right wheels, the central axes of which coincide with each other, as illustrated in FIGS. 17(a)-17(c), a relatively large load is applied to the central axis between the wheels, and a large centrifugal force is generated behind the vehicle, as illustrated in FIG. 17(a). Thus, yawing generated in a Y direction. Next, since the center of weight of the vehicle body is positioned above the central axis between the wheels, as illustrated in FIG. 17(b), rolling is generated in an R direction by centrifugal force. In addition, since centrifugal force acts on the center of weight of the vehicle body, which is positioned behind the vehicle body and above the central axis between the wheels, as illustrated in FIG. 17(c), pitching is generated in as P direction.

When the vehicle turns, the gyro pack is moved toward the center of the radius of rotation (O) such that the side of the vehicle body, which is close to the center of the radius of rotation, is not lifted due to rolling, and the wheel located close to the center of the radius of rotation is pressed so as to reinforce traction that is relatively low at the associated wheel. Moreover, it is possible to reduce a rolling phenomenon by lowering the gyro pack to the maximum such that the center of weight of the vehicle body is close to the central axis of the wheel.

In addition, the yawing of the gyro pack and/or the orientation of the axes of rotation of and rotational speeds of the flywheels of the two gyroscopes are individually controlled so as to generate the moment in the directions opposite to the rolling (R), the pitching (P), and the yawing (Y). Particularly, in terms of the rolling (R), the center of weight is preferably lowered such that the heavier rear of the vehicle body rather than the front thereof on the basis of the central axis between the wheels is closer to the ground.

While the present invention has been described with respect to the specific embodiments, it will be apparent to those skilled in the art that various changes and modifications may be made without departing from the spirit and scope of the invention as defined in the following claims.

What is claimed is:

1. An apparatus for controlling a vehicle, comprising:
a vehicle body comprising at least one wheel;
a gyro pack fixed to the vehicle body so as to be movable in at least one direction of forward and backward or left and right directions;
a movement unit that moves the gyro pack;
at least one gyroscope installed in the gyro pack;
at least one flywheel installed in the gyroscope;
a power unit that rotates the flywheel;
a tilting unit that tilts the flywheel;
a sensor for measuring at least one of states of the vehicle body, an environment around the vehicle body, and the gyro pack; and
an ECU that controls at least one of the movement unit, the power unit, and the tilting unit, based on signals measured by the sensor, wherein:
the wheel consists of a pair of left and right wheels in a direction perpendicular to a direction of progress of the vehicle body;
the wheels are driven by driving devices that are independently driven; and
the wheels are provided with steering units that independently control steering angles of the wheels.

2. The apparatus according to claim 1, wherein the gyro pack is moved relative to the vehicle body by at least one link arm connected to both of the gyro pack and the vehicle body.

3. The apparatus according to claim 1, wherein one gyroscope is provided with at least two flywheels, axes of rotation and rotation directions of which coincide with each other.

4. An apparatus for controlling a vehicle, comprising:
a vehicle body comprising at least one wheel;
a gyro pack fixed to the vehicle body so as to be movable in at least one direction of forward and backward or left and right directions;
a movement unit that moves the gyro pack;
at least one gyroscope installed in the gyro pack;
at least one flywheel installed in the gyroscope;
a power unit that rotates the flywheel;
a tilting unit that tilts the flywheel,
a sensor for measuring at least one of states of the vehicle body, an environment around the vehicle body, and the gyro pack; and
an ECU that controls at least one of the movement unit, the power unit, and the tilting unit, based on signals measured by the sensor,
wherein the gyro pack is moved relative to the vehicle body by at least one link arm connected to both of the gyro pack and the vehicle body.

5. The apparatus according to claim 4, wherein both ends of the link arm are respectively connected to the gym, pack and the vehicle body.

6. The apparatus according to claim 4, wherein a length of the link arm is individually adjustable.

7. The apparatus according to claim 6, further comprising a gyro pack pitching unit that tilts the gyro pack about an axis perpendicular to an axis of rotation and a tilt axis of the flywheel,
wherein the gyro pack pitches by adjusting the length of the link arm.

8. The apparatus according to claim 6, further comprising a gyro pack elevating unit that moves the gyro pack in upward and downward directions,
wherein the gyro pack is moved up and down by adjusting the length of the link arm.

9. The apparatus according to claim 4, further comprising a gyro pack yawing unit that rotates the gyro pack about an axis parallel to an axis of rotation of the flywheel,
wherein the gyro pack yaws by turning the link arms in opposite directions.

10. The apparatus according to claim 4, wherein one gyroscope is provided with at least two flywheels, axes of rotation and rotation directions of which coincide with each other.

11. An apparatus for controlling a vehicle, comprising:
a vehicle body comprising at, least one wheel;
a gyro pack fixed to the vehicle body so as to be movable in at least one direction of forward and backward or left and right directions;
a movement unit that moves the gyro pack;
at least one gyroscope installed in the gyro pack;
at least one flywheel installed in the gyroscope;
a power unit that rotates the flywheel;
a tilting unit that tilts the flywheel;
a sensor for measuring at least one of states of the vehicle body, an environment around the vehicle body, and the gyro pack; and
an ECU that controls at least one of the movement unit, the power unit, and the tilting unit, based on signals measured by the sensor,
wherein one gyroscope is provided with at least two flywheels, axes of rotation and rotation directions of which coincide with each other.

12. The apparatus according to claim 11, wherein the gyro pack is moved relative to the vehicle body by at least one link arm connected to both of the gyro pack and the vehicle body.

13. A method of controlling a vehicle, in order to control a gyro pack fixed to a vehicle body including a pair of left and right wheels so as to be movable in a direction perpendicular to a direction of progress of the vehicle body, the gyro pack including at least one gyroscope including at least one flywheel, the method comprising:
adjusting at least one of an orientation and a rotational speed of the flywheel provided in the gyro pack and a position of the gyro pack, based on at least one of states of the vehicle body, an environment around the vehicle body, and the gyro pack, which are measured by a sensor.

14. The method according to claim 13, wherein when a vehicle ascends or descends a slope, a distance between the vehicle and the ground is detected by the sensor and the gyro pack is at least moved forward or backward so that the vehicle body is parallel to the slope.

15. The method according to claim wherein when the sensor checks that a vehicle is predicted to roll or is in a rolling state, the gyro pack is moved to the wheel which is lifted due to the rolling, and at least one of the orientation and rotational speed of the flywheel is adjusted such that a moment is generated in a direction opposite to the rolling of the vehicle.

16. The method according to claim 13, wherein when the sensor checks that a vehicle is predicted to pitch in a direction of progress thereof or is in a pitching state in a vehicle direction, the gyro pack is at least moved in a direction opposite the direction of progress, and at least one of the orientation and rotational speed of the flywheel is adjusted such that a moment is generated in a direction opposite to the pitching of the vehicle.

17. The method according to claim 13, wherein:
when a vehicle rotates to the left or the right, the gyro pack is moved toward a center of a radius of rotation;
when the vehicle is predicted to yaw in a direction of mismatching with a rotation direction thereof or is in a yawing state, at least one of the orientation and rotational speed of the flywheel is adjusted such that a moment is generated in a direction opposite to the yawing of the vehicle; and
when the vehicle is predicted to roll in a centrifugal direction or is in a rolling state, at least one of the orientation and rotational speed of the flywheel is further adjusted such that a moment is generated in a direction opposite to the rolling of the vehicle.

18. The method according to claim 17, wherein when the vehicle rotates to the left or the right, control for lowering a height of the gyro pack is further performed.

19. The method according to claim 17, wherein when the vehicle rotates to the left or the right, at least one of the orientation and rotational speed of the flywheel is further adjusted such that a moment is generated in a direction in which a center of weight of the vehicle body is lowered so that a heavier side of front and rear sides of the vehicle body on the basis of an axis of at least wheel is closer to the ground.
